(19) United States
(12) Patent Application Publication
(10) Pub. No.: US 2015/0175235 A1
(43) Pub. Date: Jun. 25, 2015

(54) BEARING SHELL FOR A BEARING

(71) Applicant: ACROS Sport GmbH, Renningen (DE)

(72) Inventor: Frank Weidner, Gerlingen (DE)

(73) Assignee: ACROS Sport GmbH, Renningen (DE)

(21) Appl. No.: 14/411,379

(22) PCT Filed: Jun. 24, 2013
(86) PCT No.: PCT/EP2013/063158

§ 371 Date: Dec. 24, 2014

(30) Foreign Application Priority Data
Jun. 25, 2012 (DE) 20 2012 006 121.6

(51) Int. Cl. B62K 21/06; F16C 35/077

(52) U.S. Cl. CPC B62K 21/06; F16C 35/077

(57) ABSTRACT

The invention relates to a bearing shell for receiving a rolling contact bearing or ball bearing, with a cylindrical main body, in which a rolling contact bearing or ball bearing can be received, and the main body consists of a flowable material that contacts the rolling contact bearing in a sticking manner when the bearing shell is under load, such that the rolling contact bearing is retained so as to be secured against rotation in the main body. The invention further relates to a bearing comprising such a bearing shell for rotationally movable connection of two parts, and to a two wheeled vehicle having at least one such bearing.

The invention relates to a bearing shell for receiving a rolling contact bearing or ball bearing, a bearing for rotatably connecting two parts, said bearing comprising this bearing shell, and a two-wheeled vehicle having at least one such bearing.

The rotatable connection of front wheel fork and handle bar to the frame of a two-wheeled vehicle is implemented by a so-called steering head. The steering head is composed of an upper and a lower bearing unit, wherein normally the inner ring of the bearing ring can be fixedly connected to the shaft tube of the fork and the outer ring can be fixedly connected to the steering head tube, which is part of the frame of the two-wheeled vehicle. In order to achieve a bearing that is free of play in all directions, a permanently tight fit of the tubular shaft in the bearing ring has to be ensured. The outer rings are normally placed into the steering head tube or into adapter shells and are adjusted via chamfers (mostly angles of 36° or 45°) on the inner and outer rings by an expander screw via the inner rings so as to be free of play. The play between the outer ring of the bearing and the bearing shell is often several tenths of a millimeter. As a result of high braking forces of brake disks the front wheel forks deform, and transfer these high forces to the frame via the outer rings of the bearing. Due to the excessive play, the bearings tilt and loud creaking noises and even loosening of the front fork can occur.

In products with technically better solutions, the outer rings of the bearings with the adapter shells have no play with respect to the frame. In this more complex solution, the bearings are pressed into the adapter shells via the outer rings.

Here, it is often aimed at implementing a transition fit or a light interference fit. Even the embodiment of the bearings as a “light interference fit” has to have a certain degree of free movement of the entire steering head bearing unit in the assembled state.

However, this is precisely the problem of any industrial series production of steering head bearing units because low sales prices with low production costs are to be achieved. This is done in most cases by accepting very wide manufacturing tolerances of all relevant components requiring toleranced dimensions such as bearings and bearing shells.

Because normally anodized bearing shells from aluminum are used, undesirable accumulation of tolerances occurs after coating (anodizing), caused by varying layer thicknesses during the galvanization process and by ovalities which can result in high reject rates. Variations on the steering tube add to the dimensional variations on the bearing shells. These variations on the frame are caused by the manufacturing process which can result in burrs, a non-round tube or conical deformation of the steering tube. These deviations are not compensated in currently used conventional constructions which results in the fact that these faults are directly passed on to the bearing shell and thus to the rolling contact bearing. The accumulated tolerance variation often leads to premature damage to the bearing.

The invention relates to the bearing shell of the steering head bearing which usually is composed of a solid disk. The disadvantage of these conventional bearing shells is that they pass on deviations of the surrounding geometry directly to the bearing. This results in premature damages to the bearings and inaccuracies in positioning the bearings directly after assembly.

It is an object of the present invention to overcome the above-described disadvantages of a steering head bearing and to provide an improved bearing which functions securely and reliably and, at the same time, can be produced in a simple and cost-effective manner.

This object is achieved by a bearing shell for receiving a rolling contact bearing or ball bearing, with a circular cylindrical main body in which a rolling contact bearing or ball bearing can be received, and the main body consists of a flowable material which rests against the rolling contact bearing in a clamping manner when the bearing shell is under load so that that the rolling contact bearing is retained so as to be secured against rotation in the main body.

An essential aspect of the solution according to the invention is that by using a flowable material for the main body, potentially occurring dimensional inaccuracies can be subsequently compensated while providing a stable connection to the rolling contact bearing or ball bearing. Producing such a main body is likewise simpler and more cost-effective than was possible up to now in the prior art. According to the invention, tolerance variations, e.g. of a bearing tube, are compensated in that the bearing shell adapts to the deviations in dimension and shape of the shaft tube. This situation is due to the flowing of the material and the elastic deformation. As a result, the bearing ring encloses the bearing completely in an ideal manner, provides for uniform force distribution and therefore for uniform load on an outer bearing ring.

Advantageous embodiments of the bearing shell are specified in the sub-claims.

In a first preferred embodiment of the bearing shell according to the invention it is accordingly provided that the inner jacket thereof forms a clamping profile for the rolling contact bearing, which clamping profile has recesses formed thereon in sections. By weakening of a contact area to the rolling contact bearing or ball bearing received in or on the bearing shell, the flow behavior of the bearing shell material is significantly supported. Such an elastic, quasi hollowed bearing shell therefore compensates tolerance deviations, e.g. of a bearing tube, because it adapts to a certain extent to the deviations in dimension and shape of a shaft tube.

In a second preferred embodiment of the bearing shell according to the invention it is provided that the clamping profile has pockets or notches. In this manner, defined escape spaces can be formed for the material which allow for a more calculable clamping effect, depending on the specific requirements. Adequate adaptability of the material thus is implemented in that, e.g., pockets are recessed in the bearing shell at the contact points of the contacting material between the bearing shell and the rolling contact bearing or ball bearing, which pockets cause elastic deformation of the webs which rest against the rolling contact bearing or ball bearing.

In another preferred embodiment of the bearing shell according to the invention it is provided that the pockets and/or notches are formed to be round and/or edged. This permits in particular simple manufacture of these pockets and/or notches either by mechanical finishing or by a single original injection molding process.

In another preferred embodiment of the bearing shell according to the invention it is provided that the pockets and/or notches extend in the axial and/or radial direction of the main body. In such a case, it is in particular possible to influence the flow deformation of the material in a targeted manner based on the specific requirement. Thus, providing specific bearing shells, e.g., for steering head bearings of city bikes, trekking bikes or mountain bikes is possible, each of which is subjected to individual requirements.

In another preferred embodiment of the bearing shell according to the invention it is provided that the pockets and/or notches extend on an inner and/or outer jacket of the main body. This also enables targeted influencing of the flow deformation of the material based on the specific requirement, and can be varied as desired in particular in connection with appropriate alignment of the pockets and/or notches. A corresponding deformation of the pockets and/or notches on an outer jacket of the main body likewise can cause an inwardly oriented deformation, such as pockets and/or notches extending on the inner jacket of the main body.

In another preferred embodiment of the bearing shell according to the invention it is provided that the pockets and/or notches extend throughout the entire main body. This creates in particular a continuous escape space for material deforming by flowing, which enables an increased clamping effect over a larger area and permits in addition a significantly simpler manufacture of the bearing shell in a single injection molding process step.

In another preferred embodiment of the bearing shell according to the invention it is provided that on at least one of the axial ends thereof a radially inwardly oriented support surface for the rolling contact bearing is formed. Thereby, additional support in the axial direction is created for the rolling contact bearing or ball bearing in addition to the radial clamping thereof in the main body. An adequately aligned support surface can also be point-shaped in order to achieve corresponding weight savings, as it is required specifically in racing, for example.

In another preferred embodiment of the bearing shell according to the invention it is provided that the support surfaces are formed circumferentially in a plate-like manner. This provides in particular for good circumferential support of the rolling contact bearing which, moreover, can be manufactured in a simple manner in a single original injection molding process, for example.

In another preferred embodiment of the bearing shell according to the invention it is provided that a transition between the inner jacket of the main body and the support surface of the main body is reinforced. Flow deformation of the material accordingly occurring there as well is limited at this position in order not to weaken the support for the rolling contact bearing via the support surface. This ensures in particular a consistently stable mounting of the rolling contact bearing even when compensating major tolerance variations.

In another preferred embodiment of the bearing shell according to the invention it is provided that on at least one of the axial ends thereof a radially outwardly oriented location surface is formed. By means of such a planar location surface it is possible to provide a particularly weatherproof and weather-resistant connection of the bearing shell and the contact rolling bearing or ball bearing received therein to a construction part.

In another preferred embodiment of the bearing shell according to the invention it is provided that the main body is made from a thermoplastic and/or foam-extruded plastics material. A suitable thermoplastic plastics material ensures a permanently stable connection between the bearing shell and the rolling contact bearing or ball bearing, which connection functions equally securely and reliably even in the case of temperature fluctuations. A foam-extruded plastics material provides in particular for a lower weight as is usually required for components that are to be used in racing. In another variant of the invention it is additionally provided that a fiber- reinforced (e.g. glass and/or carbon fiber) plastics material is used for manufacturing the bearing shell.

The aforementioned object is also achieved by a bearing for rotatably connecting two parts that comprises the already-described bearing shell, wherein the bearing shell can be connected to the one part, and a rolling contact bearing or ball bearing is received in the bearing shell, wherein the bearing shell rests in a clamped manner against the rolling contact bearing or ball bearing due to at least partial flow deformation so that the other part can be rotatably connected to the one part via the rolling contact bearing or ball bearing and the bearing shell.

A substantial aspect of the bearing according to the invention is that tolerance variations of the parts mounted together are securely and reliably compensated. The deviations offset in this manner often relate not only to deviations of a diameter, which causes excessive compressing of the bearing, but also to roundness deviations which cause excessive point load on the fitted bearing. Moreover, local dimensional differences, such as e.g. burrs, are offset by the flexibility of the bearing shell and thus of the bearing. Consequently, the bearing according to the invention has a longer service life and also increased resilience since such a bearing can be operated under significantly better conditions. In practice, this results in significant advantages.

The aforementioned object is also achieved by a two-wheeled vehicle in which a steering set and/or a wheel hub and/or a bottom bracket comprise/comprises at least one bearing according to the invention.

The invention is schematically illustrated in the accompanying drawings, in particular by means of an exemplary embodiment. In the figures:

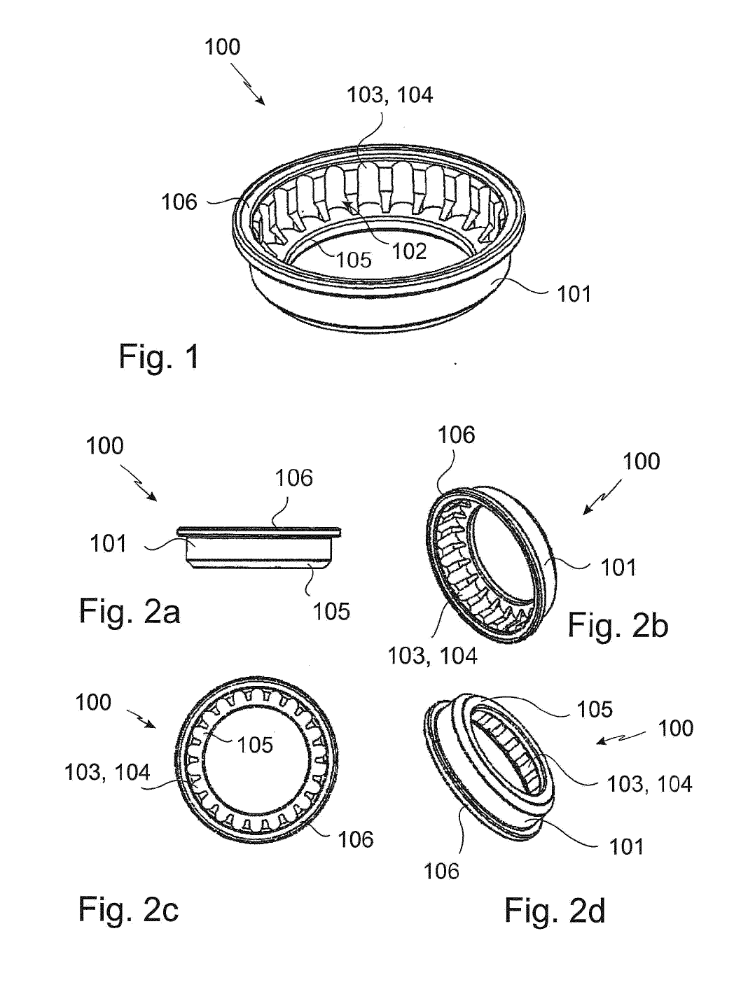

FIG. 1 shows a perspective view diagonally from above onto a bearing shell according to the invention;

FIG. 2a shows a side view of the bearing shell of FIG. 1;

FIG. 2b shows a perspective view diagonally from above onto the bearing shell of FIG. 1;

FIG. 2c shows a view from above onto the bearing shell of FIG. 1;

FIG. 2d shows a perspective view diagonally from below onto the bearing shell of FIG. 1;

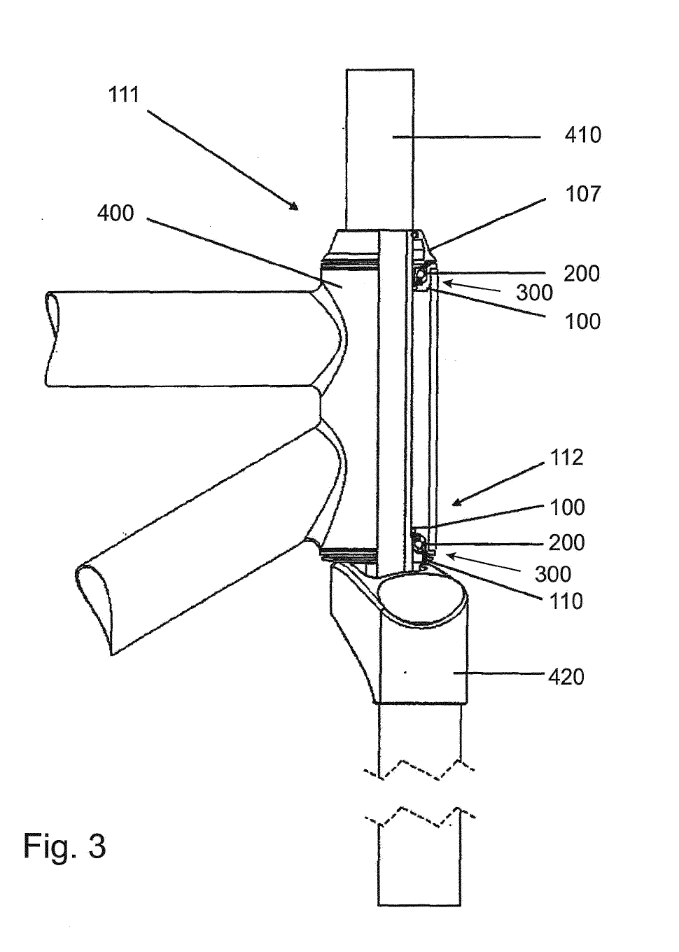

FIG. 3 shows a partially sectioned side view of a steering head of a two-wheeled vehicle having an upper and a lower bearing unit, and

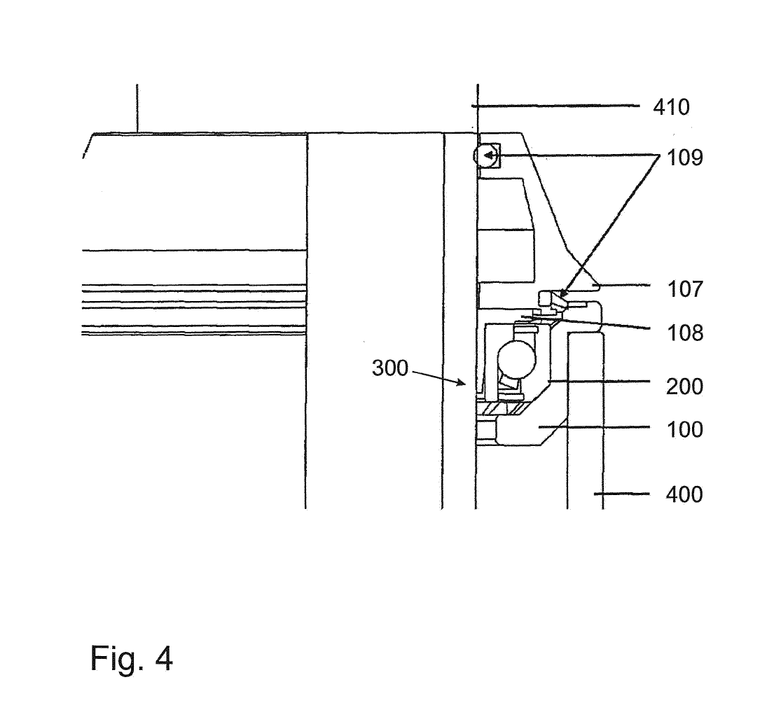

FIG. 4 shows a sectional side view of the upper bearing unit of FIG. 3.

Elements that are identical or correspond to one another are in each case designated by the same reference numbers in the Figures and are therefore not described again if it is not helpful.

FIG. 1 shows a perspective view diagonally from above onto a bearing shell 100 according to the invention, comprising a circular cylindrical main body 101 in which a rolling contact bearing or ball bearing (not shown here) can be received, and the main body 101 consists of a flowable material. When the bearing shell 100 is under load, it rests clampingly against the rolling contact bearing, thus rests with its inner jacket against the outer jacket of the rolling contact bearing so that the rolling contact bearing is held so as to be secured against rotation in the main body 101. The inner jacket of the bearing shell 100 forms a clamping profile 102 that is provided with recesses 103 which are shaped here only by way of example as corresponding pockets 104. When said bearing shell 100 engages clampingly with the rolling contact bearing or ball bearing retained therein, the web material located between the pockets 104 expands into these pockets 104 and thereby provides for secure and reliable compensation of all kinds of tolerance variations which a steering head assembled with this bearing shell 100 can comprise for many different reasons. For a weatherproof and weather-resistant connection to a corresponding construction part, the bearing shell 100 is provided with a location surface 106 which rests planar against the corresponding construction part. As a result, the rolling contact bearing or ball bearing (not shown here) is protected against corresponding influences and, as it were, is kept stable and provided with a long service life. A lower edge of the bearing shell 100 protrudes inwardly and forms a support surface 105 on which the rolling contact bearing or ball bearing can be reliably and securely supported so that the stable mounting thereof does not have to be provided solely by the radial clamping with the bearing shell 100.

FIG. 2a shows a side view of the bearing shell 100 of FIG. 1 in which the protruding location surface 106 and the specific shape of the transition from the main body 101 to the support surface 105 are shown once again. At this position, the bearing shell 100 has a chamfer extending all around so as to make the installation thereof particularly simple. Adequate stability of this transition is ensured by increased material thickness on the inside, as can be seen in FIG. 1 in the form of angled projections of the webs formed between the pockets 104.

FIG. 2b shows a perspective view diagonally from above onto the bearing shell 100 of FIG. 1, so that the recesses 103, which are formed as pockets 104, can once again be seen from this perspective. At the axial end of the bearing shell 100 facing towards the viewer, the main body 101 of the bearing shell 100 transitions into the location surface 106, and at the axial end of the bearing shell 100 facing away from the viewer, said main body transitions into the support surface 105 for the rolling contact bearing or ball bearing.

FIG. 2c shows a view from above onto the bearing shell 100 of FIG. 1, which illustrates the semicircular cross-sectional profile of the pockets 104 which can be mechanically implemented in a particularly simple manner or can be produced using an original injection molding method. It is also apparent from this top view to what extent the support surface 105 and the location surface 106 protrude from the main body 101 of the bearing shell 100.

FIG. 2d shows a perspective view diagonally from below onto the bearing shell of FIG. 1 in which once again the circumferential chamfer between the main body 101 and the support surface 105 can be seen. This chamfer, e.g., permits particularly simple self-centering of the bearing shell 100 on a tube, wherein it is particularly simple to mount the bearing shell, in particular with the rolling contact bearing or ball bearing that is already received therein.

FIG. 3 shows a partially sectioned side view of a steering head of a two-wheeled vehicle having an upper and a lower bearing unit 111, 112. A fork 420 is connected to a shaft tube 410 in a rotationally fixed manner. The shaft tube 410 is rotatably mounted in a steering tube 400 via the upper bearing unit 111 and the lower bearing unit 112. Angular ball bearings are frequently used as rolling contact bearings 200; however, other types of bearings are also possible. The steering tube 400 is part here of a two-wheeled vehicle frame, which is only partially illustrated here. The design of the frame is irrelevant for the function of the steering head bearing. The steering tube 400 has at its upper end a bearing shell 100 according to the invention for receiving the upper bearing unit 111. This bearing shell 100 is fitted into the steering tube 400 so as to ensure secure support for the outer ring of the rolling contact bearing 200 and thus to provide a bearing 300 for rotatably connecting the steering tube 400 to the shaft tube 410. A tightening part 108 provides for counter pressure from the shaft tube 410. After mounting the upper bearing unit 111, a cover 107 is slid on. The construction of the lower bearing unit 112 is principally identical except for a race 110 which is responsible for absorbing axial forces which are generated by shocks of the fork 420 and by forces of the steering tube 400.

FIG. 4 shows a sectional side view of the upper bearing unit 111 of FIG. 3, comprising a cover 107 which is sealed via seals 109 and which protects the bearing shell 100 according to the invention including the rolling contact bearing or ball bearing 200 clamped therein from above. Thus, a bearing 300 for rotatably connecting the steering tube 400 to the shaft tube 410 is provided. The tightening part 108 provides for the counter pressure from the shaft tube 410 in order to ensure a stable position of the rolling contact bearing or ball bearing 200 against the clamping forces which act between the rolling contact bearing or ball bearing 200 and the bearing shell when the “deformation effect” of the webs formed between the pockets 104 occurs.

Overall, a steering head bearing for two-wheeled vehicles is provided which has an upper and a lower bearing unit 111, 112 by means of which a shaft tube 410 that is rigidly connected to the fork 420 of the two-wheeled vehicle can be rotatably connected without play to a control tube 400 of the frame of the two-wheeled vehicle, wherein the bearing unit 111, 112 is in each case arranged in bearing shells 100 that are fixedly connected to the steering tube 400, and the bearing shell 100 has recesses 103 along its circumference. The steering head bearing provides recesses 103 which extend axially on the circumference of the bearing shell 100. Here, these recesses 103 are formed as pockets 104 and can be arranged on an inner side or outer side of the bearing shell 100 or on the inside and the outside. Moreover, the pockets 104 can be trapezoidal or can have other geometrical shapes. In any case, the bearing shells 100 can consist of a thermoplastic plastics material or die-cast aluminum. In particular, the bearing shells 100 can consist of a material with cavities, e.g. a PPE foam (extruded polypropylene), or can consist of other plastics produced by foam extrusion. Deforming the bearing shell ring can be implemented not only by the use of plastics material, but also with slightly elastically deformable materials such as, e.g., soft aluminum alloys.

The claims presently submitted with the application and claims submitted at a later time are without prejudice for obtaining more extensive protection.

Should a closer examination, in particular of the prior art, show that one or the other feature is advantageous for the object of the invention, but is not of decisive importance, a formulation is of course already endeavored which no longer comprises, in particular in the main claim, such a feature. Such a sub-combination is also covered by the disclosure of the present application.

Furthermore, it should be noted that the configurations and variants of the invention described in the various embodiments and shown in the figures can be combined with one another at will. These feature combinations are also disclosed.

The references given in the dependent claims refer to the further development of the subject matter of the main claim by the features of the respective sub-claim. However, they are not to be understood as a disclaimer of obtaining an independent objective protection for the features of the related sub-claims.

Features disclosed only in the description, or individual features from claims that comprise a plurality of features, can be incorporated at any time in the independent claim/claims as being of essential importance for the invention and for limitation against the prior art, even if such features are mentioned in connection with other features or achieve particularly favorable results in connection with other features.

1. A bearing shell (100) for receiving a rolling contact bearing or ball bearing (200), comprising a circular cylindrical main body (101) in which a rolling contact bearing or ball bearing (200) can be received and the main body (101) consists of a flowable material which rests against the rolling contact bearing (200) in a clamping manner when the bearing shell (100) is under load so that that the rolling contact bearing is retained so as to be secured against rotation in the main body (101).

2. The bearing shell according to claim 1, characterized in that the inner jacket thereof forms a clamping profile (102) for the rolling contact bearing (200), which clamping profile has recesses (103) formed thereon in sections.

3. The bearing shell according to any one of the preceding claims, characterized in that the clamping profile (102) has pockets and/or notches (104).

4. The bearing shell according to any one of the preceding claims, characterized in that the pockets and/or notches (104) are formed to be round and/or edged.

5. The bearing shell according to any one of the preceding claims, characterized in that the pockets and/or the notches (104) extend in the axial and/or radial direction of the main body (101).

6. The bearing shell according to any one of the preceding claims, characterized in that the pockets and/or the notches (104) extend on an inner and/or outer jacket of the main body (101).

7. The bearing shell according to any one of the preceding claims, characterized in that the pockets and/or the notches (104) extend throughout the entire main body (101).

8. The bearing shell according to any one of the preceding claims, characterized in that on at least one of the axial ends thereof, a radially inwardly oriented support surface (105) for the rolling contact bearing (200) is formed.

9. The bearing shell according to any one of the preceding claims, characterized in that the support surface (105) is formed circumferentially in a plate-like manner.

10. The bearing shell according to any one of the preceding claims, characterized in that a transition between the inner jacket of the main body (101) and the support surface (105) of the main body (101) is reinforced.

11. The bearing shell according to any one of the preceding claims, characterized in that on at least one of the axial ends thereof, a radially outwardly oriented location surface (106) is formed.

12. The bearing shell according to any one of the preceding claims, characterized in that the main body (101) is made of a thermoplastic and/or foam-extruded plastics material.

13. A bearing (300) for rotatably connecting two parts, comprising a bearing shell (100) according to any one of the preceding claims, wherein the bearing shell (100) can be connected to the one part, and a rolling contact bearing or ball bearing (200) is received in the bearing shell (100), wherein the bearing shell (100) rests in a clamped manner against the rolling contact bearing or ball bearing (200) due to at least partial flow deformation so that the other part can be rotatably connected to the one part via the rolling contact bearing or ball bearing (200) and the bearing shell (100).

14. A bicycle, in which a steering set and and/or a wheel hub and/or a bottom bracket comprise/comprises at least one bearing according to claim 13.
